(19) United States
(12) Patent Application Publication
(10) Pub. No.: US 2024/0039037 A1
(43) Pub. Date: Feb. 1, 2024

(54) NEGATIVE ELECTRODE-GLASS ELECTROLYTE LAYER LAMINATE, ALL-SOLID-STATE SECONDARY BATTERY INCLUDING THE SAME, AND METHOD OF MANUFACTURING THE SAME

(71) Applicants: SK On Co., Ltd., Seoul (KR); Polyplus Battery Company, Berkeley, CA (US)

(72) Inventors: Jun Nyeong YUN, Daejeon (KR); Doehee PARK, Daejeon (KR); Eunjeong YI, Daejeon (KR); Cholho LEE, Daejeon (KR); Jaechan RYU, Daejeon (KR); Han Sol LEE, Daejeon (KR); Bruce Katz, Berkeley, CA (US); Eugene Nimon, Berkeley, CA (US); Steve J. Visco, Berkeley, CA (US)

(21) Appl. No.: 17/876,202

(22) Filed: Jul. 28, 2022

(51) Int. Cl. H01M 10/0562; H01M 10/0585; H01M 4/134

(52) U.S. Cl. CPC H01M 10/0562; H01M 10/0585; H01M 4/134; H01M 2004/027

(57) ABSTRACT

A negative electrode-glass electrolyte layer laminate including a negative electrode and a glass electrolyte layer on at least one surface of the negative electrode, wherein the negative electrode includes a surface passivated lithium-containing metal foil, and the laminate electrochemically operable in the absence of external pressure, an all-solid-state secondary battery including the negative electrode-glass electrolyte layer laminate, and a method of manufacturing the negative electrode-glass electrolyte layer laminate.

This invention was made with Government support under Award No.: DE-AR0000772 awarded by the Advanced Research Projects Agency-Energy (ARPA-E), U.S. Department of Energy. The Government has certain rights in this invention.

### BACKGROUND

### 1. Field

The present disclosure relates to a negative electrode-glass electrolyte laminate, an all-solid-state secondary battery including the same, and a method of manufacturing the same.

### 2. Description of Related Art

An all-solid-state secondary battery generally includes a positive electrode, a negative electrode, and a solid electrolyte layer interposed therebetween. The solid electrolyte layer includes a solid electrolyte, and the positive and negative electrodes include an active material and generally a solid electrolyte, respectively.

The all-solid-state secondary battery has low risk of explosion or fire as compared with a battery including a liquid electrolyte, and is attracting attention as a next-generation secondary battery due to its possibility of high energy density.

In particular solid-state batteries that are based on lithium metal as the active material of the negative electrode are especially promising. Lithium metal is desirable for batteries due to its high theoretical capacity (3.86 Ah/g), low density, and electro positivity (−3.04 V vs. SHE). Lithium metal primary batteries are well known for their characteristically high cell voltages (>3 Volts), compactness, and lightweightedness. It is also well known that foils of lithium metal are surface passivated as a result of metallic lithium spontaneously reacting with oxygen to form a native oxide surface film, even when the foil is formed in an oxygen-poor environment. The native film is advantageous in that it provides the necessary surface passivation against oxidative degradation during storage and downstream processing. However, the presence of the native oxide film may, in certain instances, adversely affect cell performance, and generally does present difficulties with respect to layer adhesion (e.g., when attempting to bond or laminate a lithium metal foil and a solid electrolyte layer).

Accordingly, the present disclosure addresses layer adhesion issues associated with laminating lithium metal foils directly to solid electrolyte layers.

### SUMMARY

In one aspect the present disclosure provides a negative electrode composed of a surface passivated lithium-containing metal foil that is laminated at high homologous temperatures (HHT-laminated) to a sulfide glass electrolyte layer, the negative electrode having excellent adhesive strength between the glass electrolyte layer and the lithium-containing metal foil. In accordance with the present disclosure, the lamination is performed in a manner and at sufficiently high homologous temperature of the metal foil such that any native film (e.g., oxide, carbonate or combination thereof) on the surface of the foil is absorbed by what is termed herein a “laminating layer” which reactively forms at the interface.

The laminating layer should not impart an undue interfacial resistance, and specifically the laminate so formed has a small interfacial resistance even in a state of applying no pressure. By use of the term surface passivated it is meant that the lithium-containing metal foil, in its prelaminated state, has an oxidized or carbonated surface (i.e., a native oxide and/or carbonate film) that is substantially protective against further reaction when stored or handled in an oxygen-poor environment. In accordance with the present disclosure, the native film is absorbed by a laminating layer that is formed at the interface between the lithium-containing metal foil and the glass electrolyte layer as a result of the lamination taking place at sufficiently high homologous temperatures of at least 0.85, and specifically below the crystallization temperature of the glass electrolyte layer.

When using the term “homologous temperature” it is meant to refer to that of the lithium-containing active material of the negative electrode and is useful herein because it expresses the temperature of a material as a fraction of its melting point temperature, using the Kelvin scale. Accordingly, this allows for comparison of the working conditions of different lithium-containing metal foils and is therefore relatable to diffusion dependent deformation which may take place when laminating at high temperatures (e.g., near the melting point of the metal foil). Accordingly, the term HHT-lamination or HHT-laminate is sometimes used herein and, in the claims, when referring to a laminate formed at a homologous temperature of at least 0.85 and less than 1.

Another aspect of the present disclosure may provide a method of manufacturing a negative-electrode glass electrolyte layer laminate in which the glass electrolyte film and the lithium-containing metal foil are laminated at homologous temperatures between 0.85 to <1 (e.g., in the range of 120-180° C. for a lithium metal foil) while under a specified pressure in the range of about 0.05 to 0.3 kgf/cm². In various embodiments the laminating step is performed in an inert non-vacuum environment, such as an argon filled chamber or dry box. In a specific embodiment, the native film on the lithium metal foil surface is sufficiently robust and the laminating temperature sufficiently high to enable the laminating step to take place in a dry room environment of ambient air having a low moisture content (e.g., a dew point of −40° C. or lower). In various embodiments the native oxide film is controllably formed prior to lamination. For instance, the as-received or as-formed lithium-containing metal foil is pre-treated prior to lamination by abrading the surface in a manner that exposes fresh lithium metal to a gaseous oxygen containing environment, thus forming a controlled native oxide film, typically having a thickness of between 100 nm to 1 um.

In various embodiments the method involves melting and wetting lithium metal to form a lithium metal layer which, prior to fully cooling the lithium metal layer, is laminated to the glass electrolyte film at sufficiently high homologous temperature (e.g., from 0.85 to <1) by simply placing the solid electrolyte onto the lithium metal surface, with slight pressure).

According to an aspect of the present disclosure, a negative electrode-glass electrolyte layer laminate may include a negative electrode and a glass electrolyte layer on at least one surface of the negative electrode, wherein the negative electrode includes a lithium-containing metal foil with a native film that is sufficiently absorbed by the laminating layer and/or pushed back into the depth of the Li foil such that when a pressure applied to the negative electrode-glass electrolyte layer laminate is 0 kgf/cm² the laminate is operable for use in a battery cell.

The negative electrode-glass electrolyte layer laminate may satisfy the following Equation (1):

[|(R1−R2)|/R1]×100≤10% (1)

wherein R2 is an interfacial resistance between the negative electrode and the glass electrolyte layer when a pressure applied to the negative electrode-glass electrolyte layer laminate is 0.3 kgf/cm².

Specifically, the laminating step is performed at sufficiently high homologous temperatures and pressures that diffusion dependent deformation effectuates a negative electrode-glass electrolyte layer laminate having no pores in an interface between the negative electrode and the glass electrolyte layer.

The interface between the negative electrode and the glass electrolyte layer may include what is termed herein as a laminating layer which is formed by reaction of the lithium-containing metal and a sulfide-based glass electrolyte.

Thickness of the laminating layer is not particularly limited. It may range from about more than 0 μm and about 30 μm or less. For example, more than 0 μm, 0.001 μm or more, 0.1 μm or more, 0.3 μm or more, 0.5 μm or more, 1 μm or more, 3 μm or more, or 5 μm or more and 30 μm or less, for example, 25 um or less, 20 μm or less, 17 μm or less, or 15 μm or less. For instance, the laminating layer may have a thickness of about 20 μm.

The glass electrolyte layer may be a monolithic electrolyte layer. The glass electrolyte layer may have a thickness of 1 μm or more, for example, 3 μm or more, 5 μm or more, 10 μm or more, 20 μm or more, 50 μm or more, or 100 μm or more and 1000 μm or less, for example, 800 μm or less, 700 μm or less, 500 μm or less, 300 μm or less, or 200 μm or less. For instance, the glass electrolyte layer may have a thickness of about 200 μm or about 100 μm or about 50 μm or about 30 μm or about 20 μm or about 10 μm.

The glass electrolyte layer is based on a sulfide.

The glass electrolyte layer may include Li, S, P, Si, As, and B.

In various embodiments the method of manufacturing the negative electrode-glass electrolyte layer involves a hot lamination process which includes: providing a surface passivated lithium-containing metal foil, and layering the foil onto a sulfide-based glass electrolyte film, and performing heating and pressing to laminate the lithium-containing metal foil and the sulfide-based glass electrolyte film at a homologous temperature greater than about 0.85 and <1.

The laminating may be performed at a temperature of 140 to 180° C.

The laminating may be performed at a pressure of 0.05 to 0.3 kgf/cm².

The laminating may be performed for 5 to 30 minutes. In various embodiments, the laminating is performed for 1 minute or less (e.g., about 60 seconds, or about 50 seconds, or about 40 seconds, or about 30 seconds, or about 20 seconds, or about 10 seconds, or about 5 seconds).

In various embodiments a fast HHT lamination is employed, using a high homologous temperature approaching 1 (e.g., >0.9) for a time period of about 5 seconds or less (e.g., about 5 seconds, or about 4 seconds, or about 3 seconds, or about 2 seconds or about 1 second, or about 500 milliseconds). For example, fast laminating at a homologous temperature of between 0.95 to <1 for time period in the range of 5 to 1000 milliseconds. Because of the high homologous temperature of the fast laminating step the laminating pressure may be minimized. In various embodiments the laminate is formed by fast laminating at pressures in the range of about 0.01 to <1 kgf/cm².

The laminating step is generally performed in an oxygen poor environment, such as an inert non-vacuum environment (e.g., an argon filled chamber or dry box). However, the disclosure is not limited as such, and it is contemplated that the laminating step is sufficiently robust to tolerate laminating the layers in an air environment such as a dry room of sufficiently low moisture content.

In various embodiments, as-received lithium metal foil, or a lithium-containing metal foil is treated by abrading the surface to remove and reform the native film in a controllable manner. For instance, the lithium surface is abraded and then exposed to a controlled atmosphere environment for a certain time period. Specifically, the laminating step is performed substantially immediately after forming the native film. In various embodiments the controlled atmosphere has very low moisture content (e.g., <10 ppm H₂O). In other embodiments the atmosphere is a low oxygen containing environment such as a dry room filled with air having a dew point <40 C. According to still another aspect of the present disclosure, an all-solid-state secondary battery may include: the negative electrode-glass electrolyte layer laminate as described herein and a positive electrode.

The all-solid-state secondary battery may further include a solid electrolyte layer between the glass electrolyte layer of the negative electrode-glass electrolyte layer laminate and the positive electrode.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a drawing schematically illustrating a cross section of a negative electrode-glass electrolyte layer laminate according to an exemplary embodiment;

FIG. 2 is a drawing schematically illustrating a cross section of a conventional powder pressurized cell in which a lithium metal negative electrode and a sulfide-based electrolyte layer are in contact with each other;

FIG. 3 is a drawing conceptually illustrating a method of manufacturing the negative electrode-glass electrolyte layer laminate by laminating a lithium-containing metal foil and a glass electrolyte film by heating and pressing in Example 1;

FIG. 4 is SEM photographs of cross sections of the negative electrode-glass electrolyte layer laminate according to Example 1, taken at magnifications of 400 times (a), 1,000 times (b), and 2,000 times (c), respectively; and

FIG. 5 is a graph showing an interfacial resistance change factor depending on a pressure change, measured for the negative electrode-glass electrolyte laminate manufactured in Example 1 and a contact structure in which a negative electrode and a glass electrolyte layer are in contact with each other, manufactured in Comparative Example 1.

### DETAILED DESCRIPTION

Hereinafter, exemplary embodiments in the present disclosure will now be described in detail with reference to the accompanying drawings.

In the present specification, unless otherwise defined, all technical terms and scientific terms have the same meanings as those commonly understood by a person skilled in the art to which the present invention pertains. The terms used herein are only for effectively describing a certain specific example, and are not intended to limit the present invention.

The singular form used in the present specification may be intended to also include a plural form, unless otherwise indicated in the context.

In addition, the numerical range used in the present specification includes all values within the range including the lower limit and the upper limit, increments logically derived in a form and span in a defined range, all double limited values, and all possible combinations of the upper limit and the lower limit in the numerical range defined in different forms. Unless otherwise defined in the present specification, values which may be outside a numerical range due to experimental error or rounding of a value are also included in the defined numerical range.

The term “comprise” in the present specification is an open-ended description having a meaning equivalent to the term such as “is/are provided”, “contain”, “have”, or “is/are characterized”, and does not exclude elements, materials, or processes which are not further listed.

The term “A and/or B” in the present specification may refer to an embodiment including both A and B or may refer to an embodiment selecting one of A and B.

In the present specification, it will be understood that when an element such as a layer, film, region, or substrate is referred to as being “on” or “above” another element, it can be directly on the other element or intervening elements may also be present.

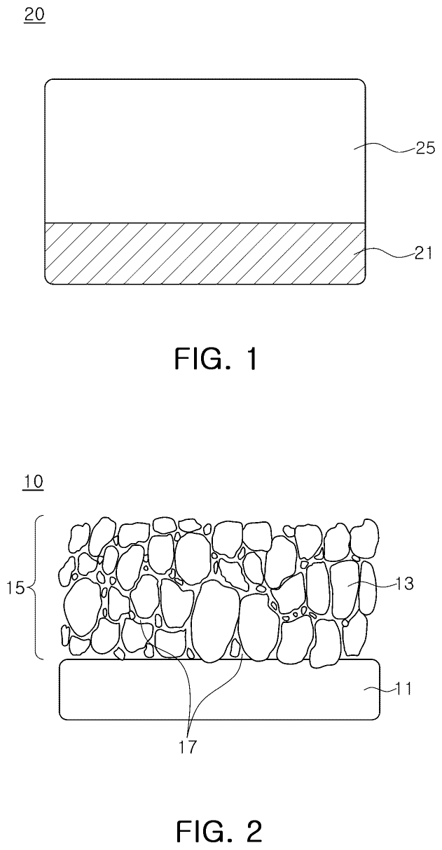

An exemplary embodiment provides a negative electrode-glass electrolyte layer laminate in which a negative electrode and a glass electrolyte film are laminated, and an example of the negative electrode-glass electrolyte layer laminate is schematically illustrated in FIG. 1.

Referring to FIG. 1, the negative electrode-glass electrolyte layer laminate 20 (hereinafter, also simply referred to as “laminate”) may include a negative electrode 21 and a glass electrolyte layer 25 at least one surface of the negative electrode 21, and specifically, the glass electrolyte layer 25 may be laminated on at least one surface of the negative electrode 21. The negative electrode 21 may be a lithium-containing metal negative electrode, and specifically, may include a lithium-containing metal foil. The glass electrolyte layer 25 is based on a sulfide, however alternative compositions are contemplated including oxides, and for example, may be based on a sulfide.

Specifically, the glass electrolyte layer 25 may be laminated on one surface of the lithium-containing metal negative electrode, and more specifically, a sulfide-based glass electrolyte layer may be laminated on one surface of the lithium-containing metal negative electrode.

As an example, the lithium-containing metal foil may be a foil made of a lithium metal alone, but also may be an alloy foil of lithium and other metals, and for example, is not limited as long as it may be used as a negative electrode in a secondary battery including a sulfide-based solid electrolyte. The metal forming an alloy with lithium may be, though is not limited thereto, a metal selected from elements of Groups 13, 14, and 15 of the periodic table, specifically, may be In, Al, Sn, Si, Mg, Zn, Ge, Ag, and the like, and any one of them may be alloyed with lithium and two or more metals may be alloyed with lithium.

As an example, the negative electrode 21 may not include a particulate negative electrode active material. More specifically, the negative electrode may not include a particulate negative electrode precipitate, in which the negative electrode precipitate may include dendrite. When the negative electrode includes the particulate negative electrode active material, pores occur in the negative electrode or on the surface of the negative electrode due to a particulate negative electrode active material, resulting in formation of a point contact between the particulate negative electrode active material and the glass electrolyte layer, and thus, a reaction active area is not sufficiently secured in the interface between the negative electrode and the glass electrolyte layer and the interfacial resistance is increased.

The glass electrolyte layer 25 is a monolithic electrolyte layer having no pore inside and interfacial resistance does not occur inside the glass electrolyte layer 25, thereby providing an excellent lithium ion conductivity. Such glass electrolyte layers are described in U.S. patent XXXX, and incorporated by reference herein.

The glass electrolyte layer 25 may be based on a sulfide, and a specific composition component is not particularly limited as long as it may contain a sulfur atom in an electrolyte component and form an amorphous state. In addition, the glass electrolyte may be a crystalline glass electrolyte (i.e., a glass ceramic) or an entirely amorphous glass electrolyte.

The sulfide-based electrolyte forming the glass electrolyte layer 25 may include Li, 5, P, Si, B, and As, and specifically, may be a LPS type sulfide including sulfur and phosphorus, Li₄₋ₓGe₁₋ₓPₓS₄ (x is 0.1 to 1, specifically, x is ¾, ⅔), Li_{10±1}MP₂X₁₂ (M=Ge, Si, Sn, Al, X═S, Se), Li_{3.833}Sn_{0.833}As_{0.166}S₄, Li₄SnS₄, Li_{3.25}Ge_{0.25}P_{0.75}S₄, Li₂S combined with one or more of P₂S₅, B₂S₃, SiS₂, and GeS₂ xLi₂S-(100-x) P₂S₅ (x is 70 to 80), Li₂S—SiS₂—Li₃N, Li₂S—P₂S₅—LiI, Li₂S—SiS₂—LiI, Li₂S—B₂S₃—LiI, and the like, but is not limited thereto.

In FIG. 2, an example of a powder pressurized cell 10 in which a particulate solid electrolyte layer 15 including a particulate solid electrolyte is formed on the surface of a lithium-containing metal negative electrode 11 is schematically illustrated.

Referring to FIG. 2, the particulate solid electrolyte layer 15 may have a plurality of pores 17 formed inside, and interfacial resistance in the particulate solid electrolyte layer 15 may be increased by the pores 17. In addition, a point contact is formed in the interface between the lithium-containing metal negative electrode 21 and the particulate solid electrolyte layer 15 to increase the interfacial resistance, and adhesive strength between the lithium-containing metal negative electrode 11 and the particulate solid electrolyte layer 15 may not be sufficiently obtained, thereby causing interlayer delamination.

Accordingly, in order to solve the problems of high interfacial resistance and interlayer delamination inside the particulate solid electrolyte layer 15 and in the interface between the lithium-containing metal negative electrode 11 and the particulate solid electrolyte layer 15, it is required for the powder pressurized cell 10 of the lithium-containing metal negative electrode and the particulate solid electrolyte layer to continuously press a battery for maintaining an interfacial contact during battery driving.

For example, an all-solid-state secondary battery including the conventional particulate solid electrolyte layer 15 needs a mean to apply or maintain a compressive stress of 5 ton/cm² or more during manufacture of an electrode, during manufacture of a battery, or during battery driving, in order to minimize an electrochemical reaction resistance occurring in the interface between the electrode and the electrolyte layer.

However, the laminate 20 according to an exemplary embodiment has an improved contactability between the negative electrode 21, specifically the negative electrode 21 including a lithium-containing metal foil and the glass electrolyte layer 25, thereby decreasing the interfacial resistance and driving the battery without separate pressing. Accordingly, since an additional pressing mean for battery driving in an electric vehicle and the like may not be required and a pressing restraint device would therefore not be required, the weight may be decreased, loading efficiency may be increased, and space utilization ability may be increased.

More specifically, the laminate 20 is integrated by laminating the glass electrolyte layer 25 on the negative electrode of a lithium-containing metal foil, thereby having excellent adhesion in the interface and reducing an interlayer delamination problem. The integration means that the two layers may be laminated in the interface without a separate binder in the interface between the negative electrode of the lithium-containing metal foil and the glass electrolyte layer 25.

Hereinafter, a method of manufacturing a laminate 20 according to an exemplary embodiment will be described.

Conventionally, when lithium-containing metal foils and sulfide based solid electrolytes (amorphous or crystalline) are laminated without heat the resulting laminate has insufficient adhesive strength and a uniform insertion and desorption process of lithium ions may not occur during a charge and discharge process, and thus leading to the forming of dendrites. In addition, the lithium-containing metal foil and the glass electrolyte film are easily delaminated. Therefore, a means to continuously provide pressure in a battery for maintaining an interfacial contact between the lithium-containing metal foil and the glass electrolyte film may be required.

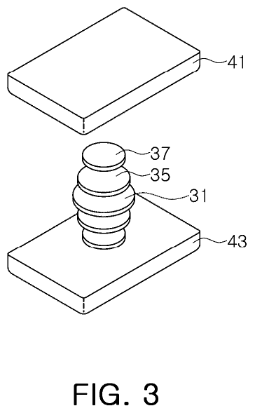

The negative electrode-glass electrolyte layer laminate according to an exemplary embodiment may be manufactured by the following method. FIG. 3 schematically illustrates a concept manufacturing the laminate according to an exemplary embodiment.

Referring to FIG. 3, in the negative electrode-glass electrolyte layer laminate 20 according to an exemplary embodiment, layering a lithium-containing metal foil and a glass electrolyte film 31 on the lithium-containing metal foil 35 is included. The lithium-containing metal foil 35 and the glass electrolyte film 31 may be as described above for the negative electrode 21 and the glass electrolyte layer 25 of the laminate 20, respectively, and the shapes of the lithium-containing metal foil 35 and the glass electrolyte film 31 are not particularly limited and a shape molded into an electrode shape to be provided may be used.

Next, manufacturing a laminate 20 in which the lithium-containing metal foil 35 and the glass electrolyte film 31 are laminated is included.

The laminating may be performed using a heating plate including an upper plate 41 and a lower plate 43, as illustrated in FIG. 3. The heating plate may heat the upper plate 41 and the lower plate 43 to a predetermined high homologous temperature and pressing to laminate the lithium-containing metal foil 35 directly to the glass electrolyte film 31.

Specifically, in various embodiments the lithium-containing metal foil 35 and the glass electrolyte film 31 are heated and pressed on both upper and lower sides, and the heating and pressing are distinguished from pressing in a state of heating an upper plate 41 or a lower plate 43 of the heating plate in the side of the lithium-containing metal foil 35 to mold a lithium metal into a predetermined shape.

The heating plate is not particularly limited as long as it may heat both sides of the upper plate 41 and the lower plate 43, and may be appropriately used as long as it includes a heating means to heat both sides of the upper plate 41 and the lower plate 43 of the heating plate.

In addition, the pressing may be applying pressure by moving any one of the upper plate 41 and the lower plate 43 or pressing by moving the upper plate 41 and the lower plate 43 so that the plates face each other.

The heating for laminating is performed at a high homologous temperature in the range of 0.85 to <1. For instance, for a lithium metal foil, the heating for laminating may be performed at a temperature of 120° C. or higher, specifically 130° C. or higher, and more specifically 140° C. or higher and at a temperature of 180° C. or lower, specifically 170° C. or lower, and more specifically 165° C. or lower. When the heating temperature is lower than 120° C. (or a homologous temperature less than 0.85), the lithium-containing metal foil 35 is not softened so that it may be difficult to laminate the foil with the glass electrolyte film 31, and when the heating temperature is higher than 180° C. (i.e., an homologous temperature of 1 or greater), the lithium-containing metal foil 35 may be melted and flow, and furthermore, the glass electrolyte film 31 may be crystallized, thereby deteriorating the conductivity of a lithium ion.

The pressure applied for the laminating is not particularly limited, but may be 0.01 kgf/cm² or more, specifically 0.3 kgf/cm² or more, and more specifically 0.05 kgf/cm² or more and 3 kgf/cm² or less, specifically 1 kgf/cm² or less, more specifically 0.5 kgf/cm² or less, and still more specifically 0.3 kgf/cm² or less. When the applied pressure is less than 0.01 kgf/cm², an interfacial contact may not be made, and when the pressure is more than 3 kgf/cm², cracks may occur on the glass electrolyte film.

A laminating time by the heating and pressing may be adjusted by the thicknesses of the lithium-containing metal foil 35 and the glass electrolyte film 31, and though is not particularly limited thereto, may be 5 to 30 minutes. When the laminating time is less than 5 minutes, a sufficient interfacial laminating between the lithium-containing metal foil 35 and the glass electrolyte film 31 may not be done, and when the laminating time is more than 30 minutes, the lithium-containing metal foil 35 may melt.

Since the glass electrolyte film 31 has low wettability to the lithium-containing metal foil 35, when the lithium-containing metal foil 35 is melted, the lithium-containing metal foil 35 is not laminated in the interface with the glass electrolyte film 31 while maintaining the plate shape, and the lithium-containing metal foil 35 may be bent and curled.

As an example, the glass electrolyte film 31 and the lithium-containing metal foil 35 are laminated by heating and pressing both up and down to soften the lithium-containing metal foil 35 to form a laminating layer in the interface between the lithium-containing metal foil 35 and the glass electrolyte film 31, and the lithium-containing metal foil 35 and the glass electrolyte film 31 are integrated by the laminating layer to form the negative electrode-glass electrolyte layer laminate 20 in which the two layers are firmly laminated.

In the negative electrode-glass electrolyte laminate 20 according to an exemplary embodiment, though the thicknesses of the negative electrode 21 and the glass electrolyte layer 25 are not particularly limited, for example, the negative electrode 21 may have a thickness of 1 μm or more, for example, 3 μm or more, 5 μm or more, 10 μm or more, 20 μm or more, 30 μm or more, or 50 μm or more and 1000 μm or less, for example, 700 μm or less, 500 μm or less, 300 μm or less, 250 μm or less, 200 μm or less, or 100 μm or less. In addition, the glass electrolyte layer 25 may have a thickness of 1 μm or more, for example, 3 μm or more, 5 μm or more, 10 μm or more, 20 μm or more, 50 μm or more, or 100 μm or more and 1000 μm or less, for example, 800 μm or less, 700 μm or less, 500 μm or less, 300 μm or less, or 200 μm or less.

In various embodiments the lithium-containing metal foil is a lithium metal foil. For instance, it may be a lithium foil that is extruded from a lithium ingot as a freestanding lithium metal foil or extruded with, or subsequently contacted, to a current collecting foil, typically a copper foil (e.g., having thickness in the range of about Sum to 15 um).

In various embodiments the laminate is formed by flash lamination at high homologous temperature in the range of 0.9 to <1 (e.g., approaching, but less than 1).

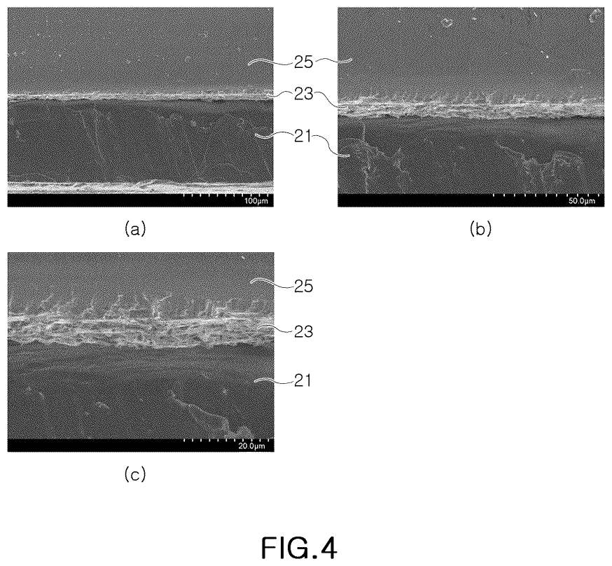

The cross section of the negative electrode-glass electrolyte layer laminate 20 according to an exemplary embodiment is illustrated in FIG. 4. FIG. 4 is SEM photographs of cross sections of the laminate 20 according to Example 1 described later, taken at magnifications of 400 times (a), 1,000 times (b), and 2,000 times (c), respectively.

Referring to each SEM photograph of FIG. 4, the laminate 20 includes a negative electrode of a lithium-containing metal 21 and a glass electrolyte layer 25, a laminating layer 23 in which a lithium metal and a glass electrolyte are mixed by softening of the lithium metal is included in the interface between the negative electrode 21 and the glass electrolyte layer 25, and the negative electrode 21 and the glass electrolyte layer 25 may be laminated by the laminating layer 23. Accordingly, the laminating layer is composed of elemental constituents of the sulfide glass electrolyte, and in particular sulfur, as well as lithium and generally other elements of the native film on the lithium surface, including one or more of oxygen and carbon (e.g., oxygen).

Specifically, the laminating layer 23 as well as the negative electrode 21 and the glass electrolyte layer 25 may have no pore.

Though the thickness of the laminating layer 23 is not particularly limited, it may be 0.1 μm or more, for example, 0.3 μm or more, 0.5 μm or more, 1 μm or more, 3 μm or more, or 5 μm or more and 30 μm or less, for example, of 25 m or less, 20 μm or less, 17 μm or less, or 15 μm or less.

As an example, the laminate 20 has no particulate in the negative electrode 21 and the glass electrolyte layer 25 to have no pore in the negative electrode 21 and the glass electrolyte layer 25, and also, has no pore in the interface and the laminating layer 23 while the two layers are laminated by the laminating layer 23, thereby maintaining the interfacial resistance between the two layers to a low value, and the laminate electrochemically operable.

Furthermore, a change rate of the interfacial resistance (R1) when the laminate 20 is not pressed (0 kgf/cm²) and the interfacial resistance (R2) between the negative electrode 21 and the glass electrolyte layer 25 when a pressure of 0.3 kgf/cm² is applied of the laminate 20 according to the present exemplary embodiment may satisfy the following Equation (1):

[|(R1−R2)|/R1]×100≤10% (1).

As such, the laminate 20 has excellent adhesive strength between the negative electrode 21 and the glass electrolyte layer 25, so that the interfacial resistance may be low and a change in the interfacial resistance before and after pressing may be small. Specifically, the peel strength of the laminate is greater than the tensile strength of lithium metal. Therefore, when the laminate 20 is used, the battery may be continuously driven even in the case in which a means to maintain separate pressure at the time of battery evaluation and battery driving is not provided.

Furthermore, a positive electrode is layered on the laminate 20 in which the negative electrode 21 and the glass electrolyte layer 25 are laminated of an exemplary embodiment, thereby manufacturing an all-solid-state secondary battery, specifically, manufacturing an all-solid-state secondary battery including a sulfide-based solid electrolyte. The positive electrode may be placed on the glass electrolyte layer 25 of the laminate 20. In addition, if necessary, a solid electrolyte layer may be further included between the positive electrode and the laminate 20, in which the solid electrolyte layer may be based on an oxide or a sulfide, but is not limited thereto.

Hereinafter, the present invention will be described in detail by way of examples. The following examples are for specifically illustrating the present invention, and the present invention is not limited thereto.

### Example 1

A lithium metal foil having a thickness of 200 μm was die cut into a circular shape having a diameter of 6 mm.

Two circular Li ion conducting sulfide-based glass electrolyte discs having a thickness of 500 μm and a diameter of 10 mm were prepared.

In a main glove box filled with argon gas, a lithium metal foil was placed on upper and lower portions of the sulfide-based glass electrolyte film, and a circular copper foil current collector having a thickness of 15 μm and a diameter of 6 mm was placed on both sides, placed between a pair of heating plates (SUS), and heated and pressed at a homologous temperature of just below 1 (about 175° C.) and a pressure of 0.2 kgf/cm² for 30 minutes to manufacture a symmetrical cell in which the sulfide-based glass electrolyte layer was laminated on upper and lower portions of the lithium metal negative electrode.

The cross sections of the lithium metal negative electrode and the sulfide-based glass electrolyte layer in the thus-manufactured symmetrical cell were taken by SEM, and the results are shown in FIG. 4. In FIG. 4, (a), (b), and (c) are SEM photographs taken at magnifications of 400 times, 1,000 times, and 2,000 times, respectively.

As seen from each SEM photographs of FIG. 4, in the laminate obtained in Example 1, it was found that the lithium metal negative electrode and the sulfide-based glass electrolyte layer were laminated by softening of the lithium metal between the lithium metal negative electrode and the sulfide-based glass electrolyte layer. Furthermore, it was found that the laminating layer as well as the lithium metal negative electrode and the sulfide-based glass electrolyte layer had no pore.

### Comparative Example 1

The current collector and the lithium metal foil which were the same as those of Example 1 were used, but the lithium metal foil was arranged on the current collector, and then pressed and laminated to manufacture two sheets of laminated bodies of the current collector and the lithium metal foil.

The laminated bodies of the current collector and the lithium metal foil manufactured above were arranged so that the lithium metal foil was in contact with both sides of the same sulfide-based glass electrolyte film as that of Example 1 and placed between the heating plates, and a symmetrical cell was manufactured in the same manner as in Example 1, except that the lithium metal foil and the sulfide-based electrolyte film were simply pressed for 30 minutes under a pressure of 0.2 kgf/cm² without heating to manufacture a contact structure.

Measurement of Interfacial Resistance

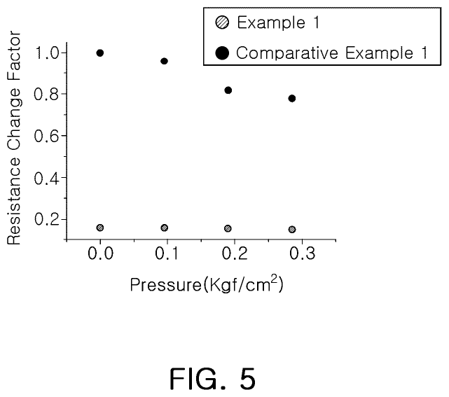

The interfacial resistance between the lithium metal negative electrode and the sulfide-based electrolyte layer was measured for the symmetrical cells obtained in Example 1 and Comparative Example 1 while changing the pressure to 0 kgf/cm² (no pressing), 0.1 kgf/cm², 0.2 kgf/cm², and 0.3 kgf/cm², and the results are shown in FIG. 5.

The interfacial resistance was measured using Potentiostat equipment available from BioLogic Sciences Instruments. Measurement conditions were set by applying an alternating voltage of 10 mV in a frequency range of 0.1 Hz to 7 MHz.

A comparison of the interfacial resistance is shown in FIG. 5. The hot laminated layer described in example 1 showed a nearly six-fold improvement over the laminate described in the comparative example, which was simply pressed at room temperature. Moreover, in contradistinction with the comparative example, the hot laminate demonstrated a small dependence on applied pressure during electrochemical testing. For example, less than a 3% decrease when increasing the applied pressure from 0.0 to 0.3 kgf/cm².

As seen from FIG. 5, when the negative electrode of Comparative Example 1 was used, the interfacial resistance (R1) when no pressure was applied was 50000Ω which is very high, and the interfacial resistance (R2) when a pressure of 0.3 kgf/cm² was applied was 40000Ω. Therefore, it was found that a pressure change with or without pressing the symmetrical cell is large and high pressure should be continuously maintained for battery driving.

However, when the symmetrical cell of Example 1 was used, the interfacial resistance (R1) when no pressure was applied was 8000Ω, which is a significantly lower value than that of Comparative Example 1. In addition, the interfacial resistance (R2) when a pressure of 0.3 kgf/cm² was applied was 7800Ω, which is a significantly lower value than the interfacial resistance value of Comparative Example 1 when the same pressure was applied to the symmetrical cell. The change rate in the interfacial resistance values when pressure was applied and when a pressure of 0.3 kgf/cm² was applied to the symmetrical cell obtained in Example 1 was only about 3%, and it was found that the interfacial resistance with or without pressing was substantially the same. In the negative electrode-glass electrolyte layer laminate according to an exemplary embodiment, a lithium-containing metal negative electrode and a glass electrolyte layer are laminated with excellent adhesion, and thus, no separate pressing for maintaining adhesion may be required for battery operation.

While exemplary embodiments have been shown and described above, it will be apparent to those skilled in the art that modifications and variations could be made without departing from the scope of the present invention as defined by the appended claims.

What is claimed is:

1. A negative electrode-glass electrolyte layer laminate comprising: a negative electrode and a sulfide glass electrolyte layer on at least one surface of the negative electrode,
wherein the negative electrode includes a surface passivated lithium-containing metal foil that is laminated directly onto a surface of the sulfide glass electrolyte layer,
wherein the interfacial resistance between the lithium-containing metal foil and the sulfide glass electrolyte layer decreases by less than 10% when a pressure of 0.3 kgf/cm² is applied to the laminate.

2. The negative electrode-glass electrolyte layer laminate of claim 1, wherein the negative electrode-glass electrolyte layer laminate has no pore in an interface between the negative electrode and the sulfide glass electrolyte layer.

3. The negative electrode-glass electrolyte layer laminate of claim 1, wherein the interface between the negative electrode and the glass electrolyte layer has a laminating layer composed of elemental constituents of the lithium-containing metal and the sulfide glass electrolyte.

4. The negative electrode-glass electrolyte layer laminate of claim 3, wherein the laminating layer has a thickness of more than 0 μm and about 20 μm or less.

5. The negative electrode-glass electrolyte layer laminate of claim 3, wherein the laminating layer has a thickness of about 0.1 μm or more and about 5 μm or less.

6. The negative electrode-glass electrolyte layer laminate of claim 1, wherein the glass electrolyte layer is a monolithic electrolyte layer.

7. The negative electrode-glass electrolyte layer laminate of claim 1, wherein the glass electrolyte layer has a thickness of 200 μm or less.

8. A method of manufacturing a negative electrode-glass electrolyte layer laminate, the method comprising:
providing a sulfide glass electrolyte sheet;
providing a lithium-containing metal foil having a passivated surface;
layering the sulfide glass electrolyte sheet onto the passivated surface of the lithium-containing metal foil; and
performing heating and pressing to laminate the lithium-containing metal foil and the glass electrolyte film;
wherein the homologous temperature of the lithium-containing metal foil, as measured nearby the interface with the sulfide glass electrolyte, is in the range of 0.85 to <1.

9. The method of manufacturing a negative electrode-glass electrolyte layer laminate of claim 8, wherein the laminating is performed such that the homologous temperature is about 0.85 or about 0.9 or about 0.95.

10. The method of manufacturing a negative electrode-glass electrolyte layer laminate of claim 8, wherein the laminating is performed in a pressure range of 0.05 to 0.3 kgf/cm².

11. The method of manufacturing a negative electrode-glass electrolyte layer laminate of claim 8, wherein the laminating is performed for 5 to 30 minutes.

12. An all-solid-state secondary battery comprising: the negative electrode-glass electrolyte layer laminate of claim 1; and a positive electrode.

13. The all-solid-state secondary battery of claim 12, further comprising: a solid electrolyte layer between a glass electrolyte layer of the negative electrode-glass electrolyte layer laminate and the positive electrode.
